(19) United States
(12) Patent Application Publication
(10) Pub. No.: US 2025/0367060 A1
(43) Pub. Date: Dec. 4, 2025

(54) PNEUMATIC COMPRESSION GARMENT FOR TREATING LYMPHEDEMA IN THE HEAD, NECK AND TORSO

(71) Applicant: Bio Compression Systems, Inc., Moonachie, NJ (US)

(72) Inventors: Jonathan Ross, Westport, CT (US); Michael Egan, Morristown, NJ (US)

(73) Assignee: Bio Compression Systems, Inc., Moonachie, NJ (US)

(21) Appl. No.: 18/935,848

(22) Filed: Nov. 4, 2024

Related U.S. Application Data
(60) Provisional application No. 63/655,221, filed on Jun. 3, 2024.

(51) Int. Cl. A61H 9/00; A41D 1/04; A42B 1/045

(52) U.S. Cl. CPC A61H 9/0092; A41D 1/04; A42B 1/045; A61H 2201/1246; A61H 2201/1604; A61H 2201/1609; A61H 2201/1614; A61H 2201/165; A61H 2205/02; A61H 2205/04; A61H 2205/062

(57) ABSTRACT

A pneumatic compression garment for treating lymphedema in the head, neck and torso of a patient is disclosed, which includes a first garment portion configured and adapted to be worn on a patient's head and including a plurality of separate and independently inflatable air chambers, and a second garment portion attached to the first garment portion and configured and adapted to be worn of the patient's torso and including a plurality of separate and independently inflatable air chambers.

### CROSS-REFERENCE TO RELATED APPLICATIONS

The subject application claims the benefit of priority to U.S. Provisional Patent Application Ser. No. 63/655,221, filed Jun. 3, 3024, the disclosure of which is incorporated herein by reference in its entirety.

### BACKGROUND OF THE INVENTION

### 1. Field of the Invention

The subject invention is directed to a device for managing lymphedema, and more particularly, to a pneumatic compression garment for treating lymphedema in the head, neck and torso of a patient.

### 2. Description of Related Art

The lymphatic system is made up of many nodes and vessels that carry lymph fluid through the body. Lymph fluid is composed of proteins, salts, water, and white blood cells, and its function is to fight infection. The lymphatic system transports lymph fluid through a network of vessels to the heart. The lymph system also includes lymph nodes, which are small bundles of tissue located along the lymph vessels. Lymph nodes function to filter harmful substances from lymph fluid. When the lymphatic system is damaged by radiation or surgery, for example, lymph fluid cannot properly flow to the heart, and it tends to collect under the skin, which causes swelling. This swelling is called lymphedema.

Lymphedema is common in head and neck cancer patients due to the considerable number of lymph nodes and vessels in and around the head and neck. In head and neck cancer, lymphedema can be caused by surgery to remove lymph nodes and vessels, radiation that causes scarring and damage to the lymph nodes and vessels, affecting their ability to remove lymph fluid from the area, or a tumor that can block or disrupt the flow of lymph fluid out of the area.

Lymphedema in head and neck cancer patients can occur in the face, head, or neck. Swelling can be internal, in locations such as the mouth, tongue, voice box, or throat. Or, swelling can be external, occurring in the neck and face. Treatment for lymphedema often consist of complete decongestive therapy (CDT). CDT includes: manual lymphatic drainage to promote the flow of lymph fluids out of the area; compression garments that can be worn around the chin, face, and head to encourage lymphatic fluids to be reabsorbed by the body as disclosed for example in U.S. Pat. No. 11,311,450; and/or exercises to strengthen muscles and increase range of motion in the neck and shoulders, which can reduce swelling.

The subject invention is directed to a new and useful pneumatic compression garment that can be comfortably worn and easily used by a patient to treat lymphedema in the head, neck and torso.

### SUMMARY OF THE DISCLOSURE

The subject invention is directed to a new and useful pneumatic compression garment for treating lymphedema in the head, neck and torso of a patient. The compression garment includes two garment portions. A first garment portion configured as a hood to be worn on a patient's head, which has a plurality of separate and independently inflatable air chambers. And a second garment portion attached to the first garment portion and configured as a vest to be worn on the patient's torso or trunk, and it too includes a plurality of separate and independently inflatable air chambers.

The first garment portion preferably includes a separable chin strap that has a hook and loop type fastener arrangement associated therewith, and the second garment portion preferably includes a zippered front section to enable a patient to readily don the garment for use and remove the garment after use.

The garment further includes a tube set that has a first group of air tubes corresponding to the plurality of inflatable air chambers in the first garment portion and a second group of air tubes corresponding to the plurality of inflatable air chambers in the second garment portion. The first group of air tubes in the tube set is operatively associated with a first pump connector manifold and the second group of air tubes in the tube set is operatively associated with a second pump connector manifold. Preferably, each inflatable air chamber of the garment has a tube connector associated therewith, and each tube connector includes a flange that is heat sealed to an interior surface of the garment.

In an embodiment of the subject disclosure, the first garment portion has four separate and independently inflatable air chambers and the second garment portion also has four separate and independently inflatable air chambers. However, it is envisioned that each garment portion can have fewer than four inflatable air chambers or more than four inflatable air chambers.

Preferably, the first garment portion includes a front air chamber adapted and configured to partially surround the patient's face and forehead area, a medial upper air chamber adapted and configured to partially surround the patient's face and upper rear head area, a medial lower air chamber adapted and configured to partially surround the patient's lower rear head area and a bottom air chamber adapted and configured to partially surround the patient's rear neck area. The size and shape of the air chambers can vary by design.

The four separate inflatable air chambers of the second garment portion extend substantially around the entire perimeter of the garment to provide therapeutic compression to the torso or trunk a patient. These include a lower air chamber, an upper air chamber and two medial air chambers therebetween. The upper air chamber is in fluid communication with a left subordinate air chamber configured to surround the patient's left shoulder area and a right subordinate air chamber configured to surround the patient's right shoulder area. Preferably, a left bridging tube extends between the upper air chamber of the second garment portion and the left subordinate air chamber to facilitate fluid communication therebetween and a right bridging tube extends between the upper air chamber of the second garment portion and the right subordinate air chamber to facilitate fluid flow therebetween. Preferably, interior dual left and right axilla air chambers are in respective fluid communication with the left and right subordinate air chambers for applying compression to a patient's underarm areas.

These and other features of the pneumatic compression garment of the subject disclosure will become more readily apparent to those having ordinary skill in the art to which the subject invention appertains from the detailed description of the preferred embodiments taken in conjunction with the following brief description of the drawings.

### BRIEF DESCRIPTION OF THE DRAWINGS

So that those skilled in the art will readily understand how to make and use the pneumatic compression garment of the subject disclosure, preferred embodiments thereof will be described in detail herein below with reference to the figures wherein:

FIG. 1 is an illustration of the pneumatic compression garment of the subject disclosure in an inflated condition applying compression to the patient's head, neck and torso, as viewed from the front of the patient;

FIG. 2 is an illustration of the pneumatic compression garment shown in FIG. 1, as viewed from the back of the patient;

FIG. 3 is a front plan view of the pneumatic compression garment of the subject disclosure in an uninflated condition;

FIG. 4 is a front plan view of the pneumatic compression garment of the subject disclosure as shown in FIG. 3, with the outer layer of the garment partially broken away to illustrate internal compression chambers;

FIG. 5 is a rear plan view of the pneumatic compression garment of the subject disclosure in an uninflated condition;

FIG. 6 is a rear plan view of the pneumatic compression garment of the subject disclosure as shown in FIG. 5, with the outer layer of the garment partially broken away to illustrate internal compression chambers;

FIG. 7 is an illustration of the pneumatic compression garment of the subject disclosure as the internal chambers of the garment are inflated, as viewed from the front of the patient;

FIG. 8 is an illustration of the pneumatic compression garment of the subject disclosure as the internal chambers of the garment are inflated, as viewed from the back of the patient;

FIG. 9 is a cross-sectional view taken along line 9-9 of FIG. 7, illustrating internal chambers of the garment in the patient's left shoulder area;

FIG. 10 is a cross-sectional view taken along line 10-10 of FIG. 7, illustrating internal chambers of the garment in the patient's left abdominal area;

FIG. 11 is a localized interior view of the junction between the left subordinate chamber and the left internal axilla air chambers of the garment;

FIG. 12 is a left side elevational view of the head portion of the garment in an uninflated condition; and

FIG. 13 is a left side elevational view of the head portion of the garment as the internal chambers thereof are being inflated.

### DETAILED DESCRIPTION OF THE EMBODIMENTS

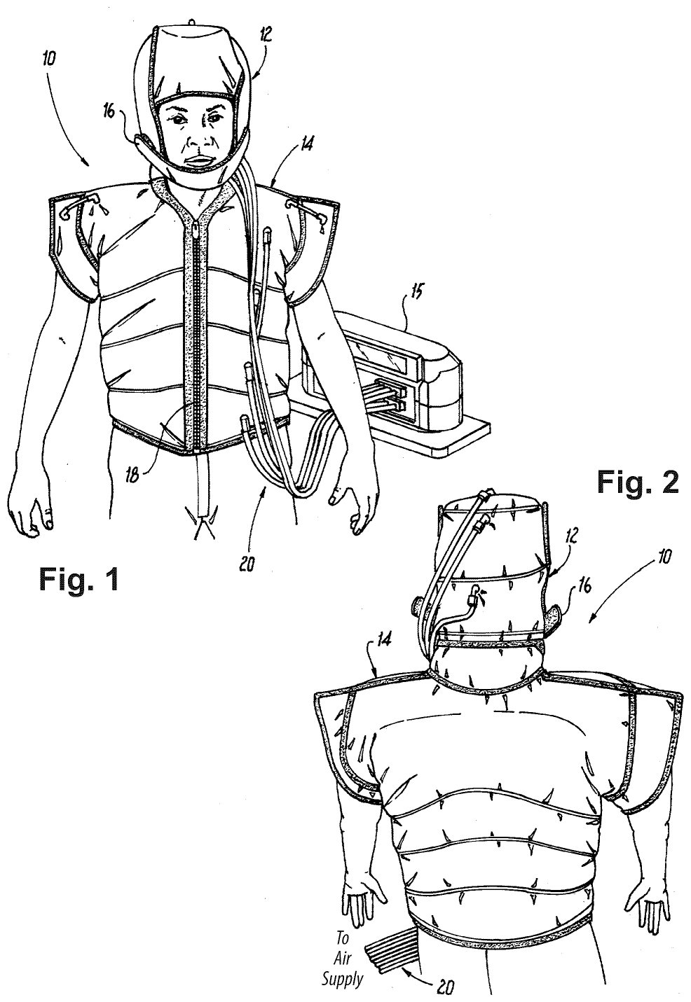

Referring now to the drawings wherein like reference numerals identify similar features of the subject disclosure, there is illustrated in FIG. 1 a new and useful pneumatic compression garment for treating lymphedema in the head, neck and torso of a patient, which is designated generally by reference numeral 10.

Referring to FIGS. 1 and 2, compression garment 10 is preferably constructed from a lightweight, airtight, water resistant thermoplastic material or coated thermoplastic fabric, which can be die cut into shaped components, trimmed and heat welded or fused together in predetermined locations to form the garment. For example, the compression garment 10 may be fabricated from a material such as 200 Denier Nylon Oxford, coated with 3 mil of polyurethane to assure a level of water resistance that allows the garment to be readily cleaned.

The compression garment 10 includes a first garment portion 12 that is configured as a hood to be worn on a patient's head and a second garment portion 14 that is attached to or otherwise integrally formed with the first garment portion 12 and is configured as a vest to be worn on the patient's torso. The first garment portion 12 and the second garment portion 14 each have a plurality of independently inflatable air chambers formed or otherwise defined therein for applying dynamic compression to the head, neck and torso of a patient to treat lymphedema. The air chambers may be inflated to one or more different pressures in a variety of different sequences or cycles to provide therapy to the patient by moving lymph from one region of the head, neck and torso to another region of the head, neck and torso.

The first garment portion 12 of compression garment 10 preferably includes a separable chin strap 16 that includes a hook and loop type fastener arrangement for securing the chin strap 16 to the hood-like garment portion 12, which has complementary hook and loop type fastening areas. The chin strap 16 functions as a static pressure portion of the garment 10, applying a static pressure to the region under a patient's chin, which can be decreased or increased depending upon how and/or where the patient secures the hook and loop type fastener. Those skilled in the art will readily appreciate that other fastening mechanisms can be used to secure the chin strap 16 to the garment 10, including, for example, buttons, snaps or clasps.

The second vest-like garment portion 14 of garment 10 preferably includes a zipper mechanism 18 located on the front section thereof to enable a patient to readily don the compression garment 10 for use and to easily remove the garment 10 after use. The zipper mechanism 18 is designed with automatic locking sliders to ensure that the garment portion 14 will not unzip accidentally when inflated. Moreover, the zipper mechanism 18 ensures a proper fit to prevent migration of the garment 10 while is use. Those skilled in the art will readily appreciate that other types of closure mechanisms can be employed on garment portion 14 instead of a zipper mechanism, including, for example, hook and loop type fasteners, buttons, snaps or clasps.

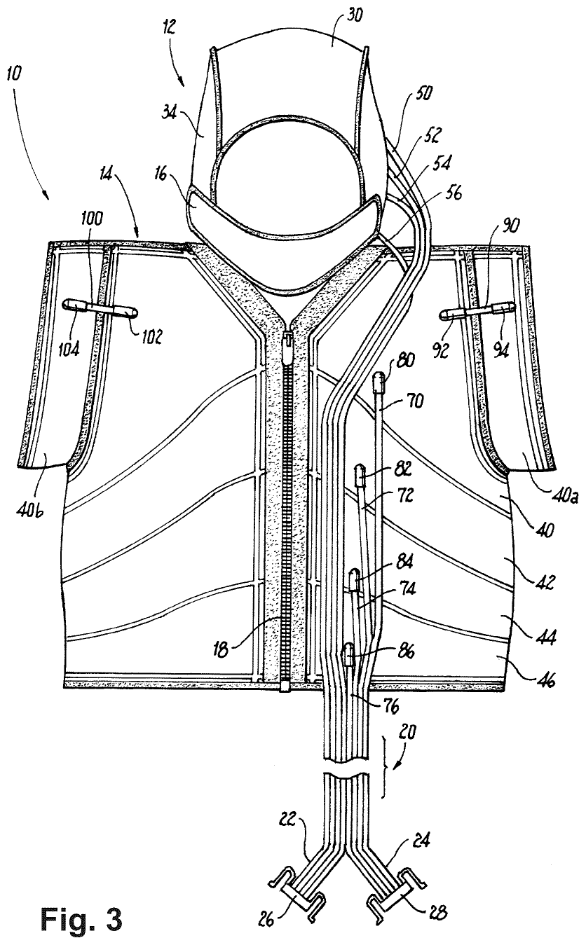

The compression garment 10 further includes a tube set 20 for connecting the garment 10 to a portable pneumatic air pump 15, as shown for example in FIG. 1. The tube set 20 has a first group of air tubes 22 corresponding to the plurality of inflatable air chambers in the first garment portion 12 and a second group of air tubes 24 corresponding to the plurality of inflatable air chambers in the second garment portion 14, as illustrated in FIG. 3.

The first group of air tubes 22 in tube set 20 is operatively associated with a first pump connector manifold 26 and the second group of air tubes 24 in tube set 20 is operatively connected to a second pump connector manifold 28. Connector manifolds 26 and 28 are preferably designed with a quick-connect flexible clipping system for connection with the air pump 15. Preferably, indicia is provided on each connector manifold 26, 28 to align with similar indicia on the pump 15 to ensure that a reliable connection is made.

A suitable eight chamber pneumatic pump for use with garment 10 and tube set 20 is available from Bio Compression Systems of Moonachie, NJ and is sold under the designation SC-4008-DL. This pump has a digital touch screen to enable a user to program the pressure in any or all of the air chambers of the compression garment 10. The pump 15 has an adjustable pressure range between 10 mmHg and 120 mmHg in all chambers, and an adjustable cycle time between 60 and 120 seconds in 15 second increments. This allows a user to adjust treatment for comfort as well as effectiveness. A compliance meter is also provided to allow the patient to keep track of the number of hours the pump 15 has been in use. Alternatively, a pneumatic pump sold under the designation SC-2008-DL, can be used with garment 10 and tube set 20. This pump allows pressure adjustment in the distal-most chamber and then it automatically calibrates the other air chambers based thereon.

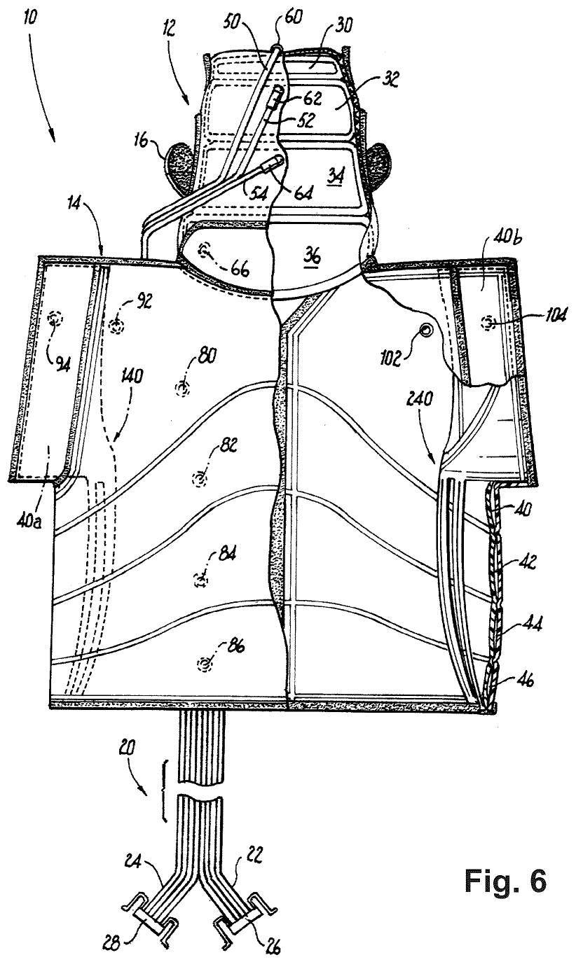

Preferably, each inflatable air chamber of compression garment 10 has a right-angled or otherwise L-shaped tube connector associated therewith that correspond with an air tube of the tube set 20, and each tube connector includes an annular flange that is RF welded or otherwise sealed to an interior surface of the garment 10, as best seen in FIGS. 6, 9 and 10.

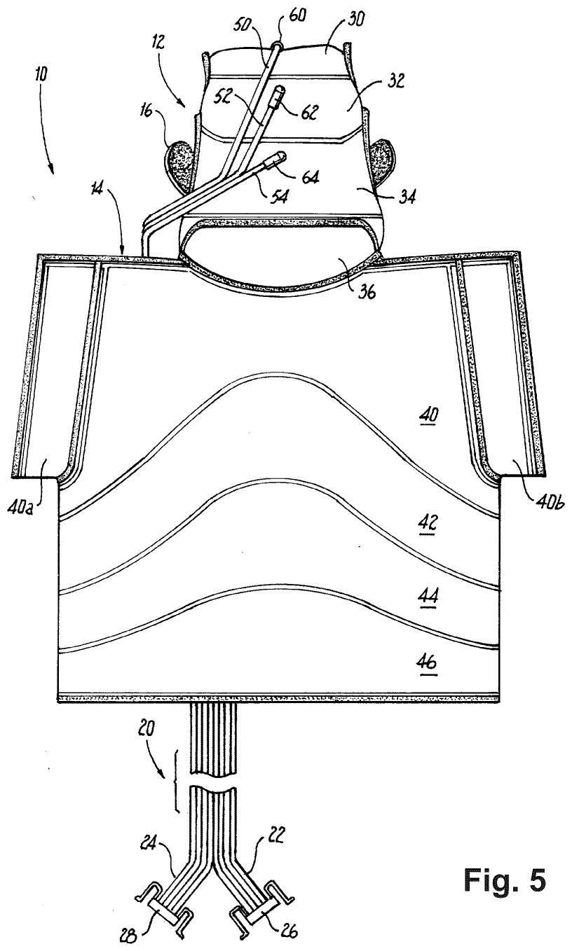

Referring to FIGS. 3 through 6, the first portion 12 of compression garment 10 has four separate and independently inflatable air chambers. These include air chambers 30, 32, 34 and 36. The second garment portion 14 also has four separate and independently inflatable air chambers. These include air chambers 40, 42, 44, and 46. However, it is envisioned that each garment portion 12, 14 can have fewer than four inflatable air chambers or more than four inflatable air chambers depending upon the overall size and configuration of the garment. That being said, it is envisioned that the compression garment 10 would be manufactured in a variety of sizes, including for example, extra-small, small, medium, large and/or extra-large to accommodate patients of distinct size, weight and/or stature.

The first air chamber 30 of garment portion 12 is the upper-most chamber and it is adapted and configured to partially surround the patient's posterior scalp region and anterior forehead area. Air chamber 30 is operatively associated with air tube 50 of the first tube group 22 of tube set 20. More particularly, air tube 50 is connected to air chamber 30 by tube connector 60. The second air chamber 32 of garment portion 12 is the medial upper air chamber and it is adapted and configured to partially surround the patient's cheeks and upper posterior head area. Air chamber 32 is operatively associated with air tube 52 of the first tube group 22 of tube set 20. More particularly, air tube 52 is connected to air chamber 32 by tube connector 62.

The third air chamber 34 is the medial lower air chamber of garment 12 and it is adapted and configured to partially surround the patient's lower posterior head area. Air chamber 34 is operatively associated with air tube 54 of the first tube group 22 of tube set 20. More particularly, air tube 54 is connected to air chamber 34 by tube connector 64. The fourth air chamber 36 is the bottom or lower air chamber of garment portion 12 and it is adapted and configured to partially surround the patient's posterior neck area. Air chamber 36 is operatively associated with air tube 56 of the first tube group 22 of tube set 20. More particularly, air tube 56 is connected to air chamber 36 by tube connector 66.

The four separate inflatable air chambers 40, 42, 44 and 46 of the second garment portion 14 extend substantially around the entire perimeter of the compression garment 10 for applying compression to the shoulders and torso of a patient. The four air chambers of garment portion 14 have curved, wave-like contours that are designed to optimize compression in critical anatomical areas. The first air chamber 40 of garment portion 14 is the upper-most chamber and it is adapted and configured to partially surround the circumference of the patient's shoulders, upper back area and upper breast or chest area. Air chamber 40 is operatively associated with air tube 70 of the second tube group 24 of tube set 20. More particularly, air tube 70 is connected to air chamber 40 by tube connector 80.

The second air chamber 42 of garment portion 14 is the medial upper air chamber and it is adapted and configured to partially surround the circumference of the patient's thoracic or lower chest area, providing compression to the rib cage. Air chamber 42 is operatively associated with air tube 72 of the second tube group 24 of tube set 20. More particularly, air tube 72 is connected to air chamber 42 by tube connector 82.

The third air chamber 44 is the medial lower air chamber of garment 14 and it is adapted and configured to partially surround the circumference of the patient's upper abdominal area. Air chamber 44 is operatively associated with air tube 74 of the second tube group 24 of tube set 20. More particularly, air tube 74 is connected to air chamber 44 by tube connector 84. The fourth air chamber 46 is the bottom or lower air chamber of garment portion 14 and it is adapted and configured to partially surround the circumference of the patient's lower abdominal area. Air chamber 46 is operatively associated with air tube 76 of the second tube group 24 of tube set 20. More particularly, air tube 76 is connected to air chamber 46 by tube connector 86.

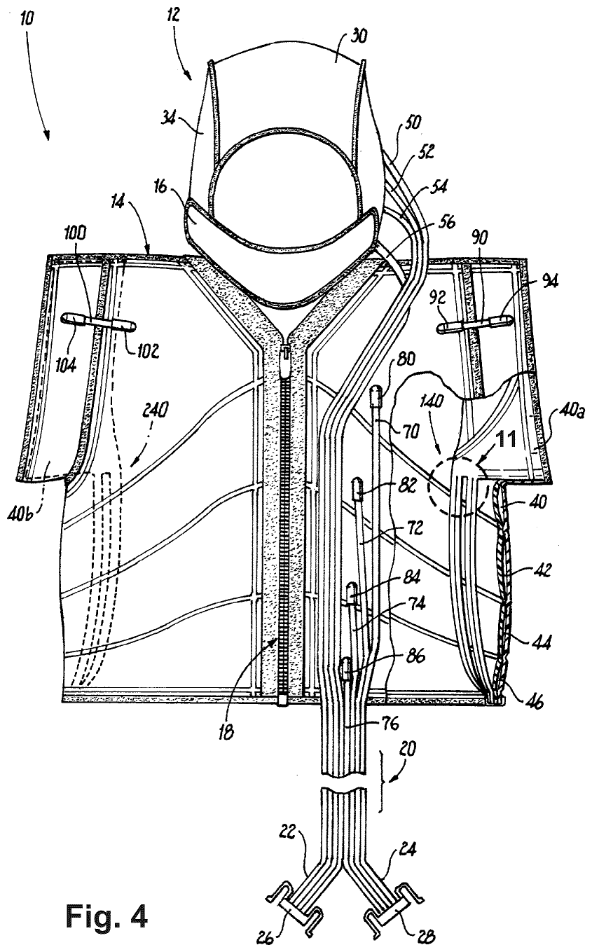

Referring back to the first or upper-most air chamber 40 of garment portion 14, with particular reference to FIGS. 3 and 4, air chamber 40 is in fluid communication with a left subordinate air chamber 40a configured to surround the patient's left shoulder area and with a right subordinate air chamber 40b configured to surround the patient's right shoulder area. A left bridging tube 90 extends between the upper air chamber 40 and the left subordinate air chamber 40a to facilitate fluid communication therebetween. The left bridging tube 90 extends between a tube connector 92 associated with air chamber 40 and a tube connector 94 associated with air chamber 40a. A right bridging tube 100 extends between the upper air chamber 40 and the right subordinate air chamber 40b to facilitate fluid flow therebetween. The right bridging tube 100 extends between a tube connector 102 associated with air chamber 40 and a tube connector 104 associated with air chamber 40b. During use, inflation of the air chamber 40 will coincide with the inflation of subordinate air chambers 40a and 40b.

As best seen in FIGS. 4 and 6, garment portion 14 also includes dual left and right interior axilla air chambers 140 and 240 that extend downwardly from the left and right subordinate air chambers 40a and 40b, respectively, along the entire length of the garment. These interior axilla air chambers are connected or otherwise fixedly attached to the base of garment portion 14 below the fourth air chamber 46. The dual axilla chambers 140, 240 are adapted and configured to provide compression to the patient's armpit areas, and more particularly, the anatomical regions located under the shoulder joints where the arms connect to the shoulders. This area contains a variety of neurovascular structures, including the axillary artery, axillary vein, brachial plexus and lymph nodes. The axilla regions are of particular concern in patient's experiencing lymphedema following breast cancer surgery. The structure and function of the dual axilla chambers 140 and 240 will be described in more detail below with reference to FIG. 11.

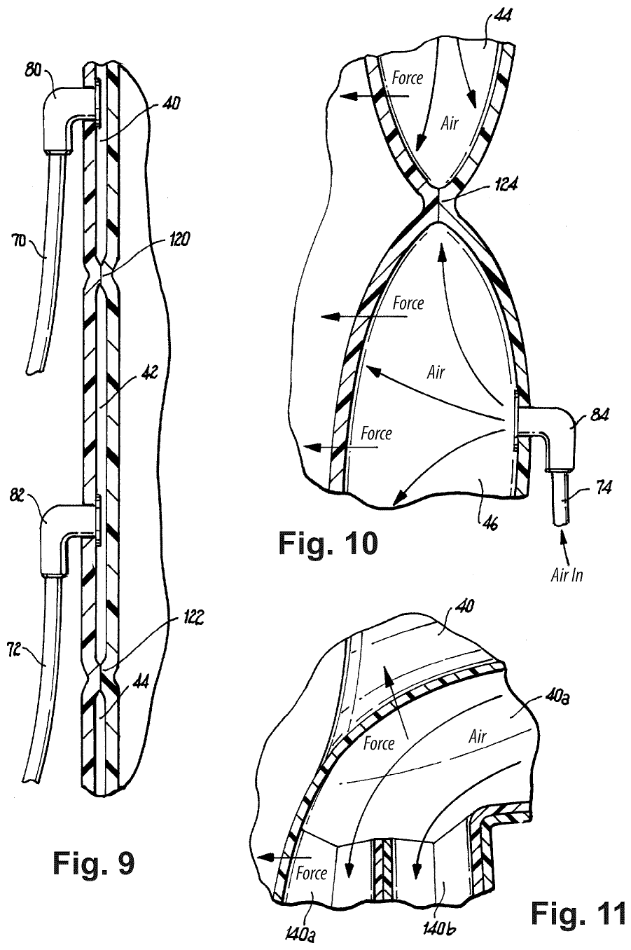

Referring now to FIGS. 9 and 10, each of the air chambers of the compression garment 10 are separated from another by RF welding or heat sealing in a predefined pattern to ensure optimum air flow. The construction of these independently controlled pressure chambers ensures that there is no gapping, peaks and valleys or bleed-through with delivered pressure.

By way of example, FIG. 9 shows the upper medial chamber 42 defined by an upper internal weldment 120 and a lower internal weldment 122. The upper internal weldment 120 separates air chamber 40 from air chamber 42, while the lower internal weldment 122 separates air chamber 44 from air chamber 42. The use of RF welding in the construction of the air chambers of garment 10 guarantees that there will be no leaking or breaking. Similarly, FIG. 10 shows the internal weldment 124 that separate the lower air chamber 46 of garment portion 14 from the lower medial air chamber 44 of garment portion 14.

Preferably, the pump 15 includes a programmable controller that can be programmed to control the air pressure applied by the air chambers of garment 10 to conduct a prescribed or optimal therapy regimen for the treatment of lymphedema. It is envisioned that the controller could be programmed to apply equal pressure within each air chamber of the garment 10 or the controller could be programmed to apply varying or differential pressure in one or more air chambers of the garment 10 at the same or at various times or cycles. The controller could also be programmed to sequentially inflate and/or deflate the chambers in the garment 10, and the inflation/deflation sequence can be programmed to vary in duration.

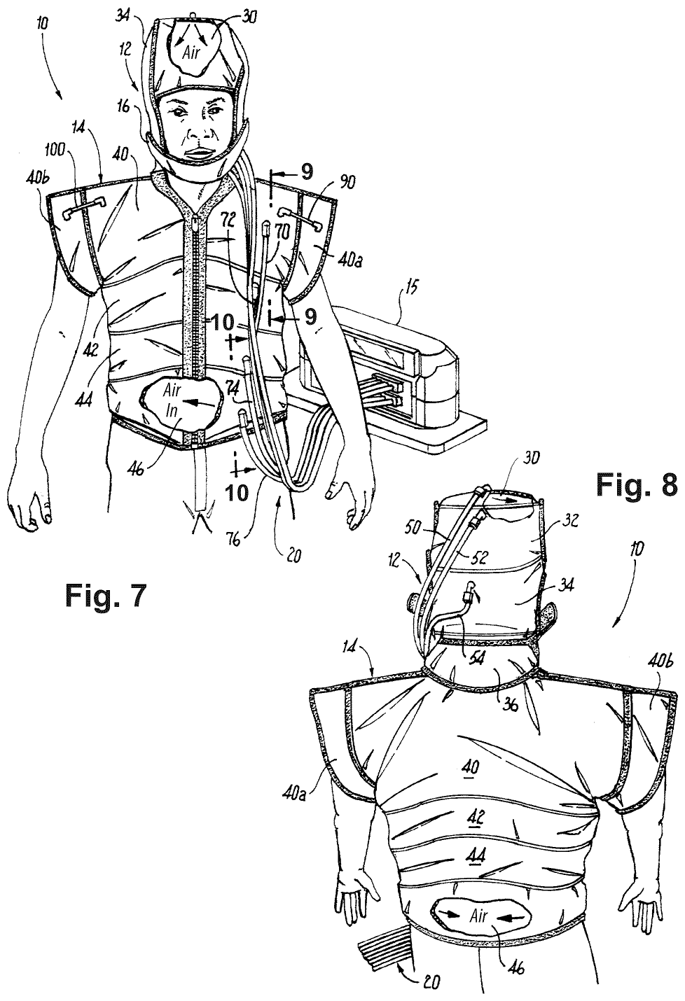

Referring back now to FIGS. 7 and 8, there is illustrated the compression garment 10 worn by a patient during an inflation cycle to treat lymphedema, wherein garment portions 12 and 14 are inflated by pump 15 through tube set 20. By way of example, the lower air chamber 46 of garment portion 14 is inflated throughout the entirety of its circumference so that equal pressure can be applied around the entirety of the patient's abdominal region. Air chambers 44, 42 and 40 are sequentially inflated thereafter.

Upon inflating the upper-most air chamber 40, the subordinate air chambers 40a and 40b that are in fluid communication therewith are subsequently inflated. Thereafter, as illustrated in FIG. 11, air from the left subordinate air chamber 40a flows into and fills the left dual axilla chamber sections 140a, 140b, applying compressive force against the patient's underarm region to effectively treat lymphedema. A similar communicative air flow pattern exists at the junction between the right subordinate air chamber 40b and the right dual axilla air chamber 240 shown in FIGS. 4 and 6.

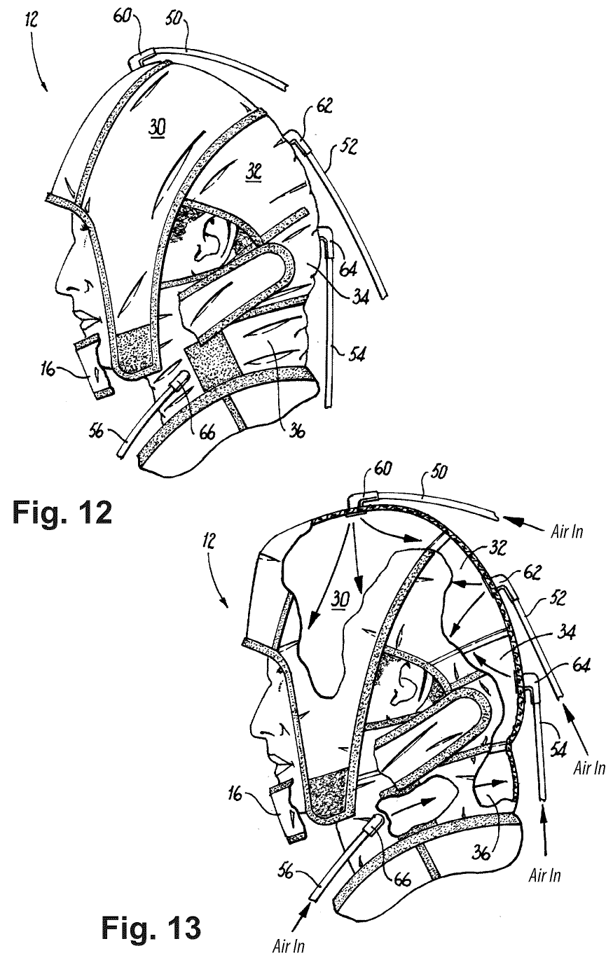

Similarly, the sequential inflation of the four chambers 30, 32, 34 and 36 of garment portion 12 by pump 15 through tube group 22 of tube set 20 is illustrated in FIGS. 12 and 13. As best seen in FIG. 13, each of the independently inflatable air chambers of garment portion 12 are internally separated from one another by RF weldments to ensure optimum air flow therein.

While the subject disclosure has been shown and described with reference to preferred embodiments, those skilled in the art will readily appreciate that changes and/or modifications may be made thereto without departing from the spirt or scope of the subject disclosure.

What is claimed is:

1. A pneumatic compression garment for treating lymphedema in the head, neck and torso of a patient, comprising:
a) a first garment portion configured and adapted to be worn on a patient's head and including a plurality of inflatable air chambers; and
b) a second garment portion attached to the first garment portion and configured and adapted to be worn on the patient's torso and including a plurality of inflatable air chambers.

2. A pneumatic compression garment as recited in claim 1, wherein the first garment portion has four separate and independently inflatable air chambers.

3. A pneumatic compression garment as recited in claim 1, wherein the second garment portion has four separate and independently inflatable air chambers.

4. A pneumatic compression garment as recited in claim 1, further comprising a tube set including a plurality of air tubes, and wherein each air tube in the tube set corresponds to one of the inflatable air chambers in the first and second garment portions.

5. A pneumatic compression garment as recited in claim 1, further comprising a pump for communicating with the tube set for inflating the plurality of air chambers in the first and second garment portions.

6. A pneumatic compression garment as recited in claim 1, wherein the first garment portion is constructed as a hood and the hood includes a separable chin strap that has a hook and loop type fastener arrangement associated therewith.

7. A pneumatic compression garment as recited in claim 1, wherein the second garment portion is constructed as a vest and the vest has a zipper mechanism on a front section thereof for opening and closing the garment.

8. A pneumatic compression garment as recited in claim 4, wherein each inflatable air chamber has a tube connector associated therewith, each of which includes a flange that is heat sealed to an interior surface of the garment.

9. A pneumatic compression garment as recited in claim 2, wherein the first garment portion includes a front air chamber adapted and configured to partially surround the patient's face and forehead area, a medial upper air chamber adapted and configured to partially surround the patient's face and upper rear head area, a medial lower air chamber adapted and configured to partially surround the patient's lower rear head area and a bottom air chamber adapted and configured to partially surround the patient's rear neck area.

10. A pneumatic compression garment as recited in claim 3, wherein the four separate inflatable air chambers of the second garment portion extend substantially around an entire perimeter of the garment and include a lower air chamber, an upper air chamber and two medial air chambers therebetween, wherein the upper air chamber is in fluid communication with a left subordinate air chamber and a right subordinate air chamber, and wherein each subordinate air chamber is configured to surround a patient's shoulder area.

11. A pneumatic compression garment as recited in claim 10, wherein a left bridging tube extends between the upper air chamber of the second garment portion and the left subordinate air chamber to facilitate fluid communication therebetween and a right bridging tube extends between the upper air chamber of the second garment portion and the right subordinate air chamber to facilitate fluid flow therebetween.

12. A pneumatic compression garment as recited in claim 10, wherein interior left and right axilla air chambers are in respective fluid communication with the left and right subordinate air chambers.

13. A pneumatic compression garment for treating lymphedema in the head, neck and torso of a patient, comprising:
a) a first garment portion configured as a hood to be worn on a patient's head and including a plurality separate and independently inflatable air chambers;
b) a second garment portion attached to the first garment portion and configured as a vest to be worn on the patient's torso and including a plurality of separate and independently inflatable air chambers; and
c) a tube set including a first group of tubes corresponding to the plurality of inflatable air chambers in the first garment portion and a second group of tubes corresponding to the plurality of inflatable air chambers in the second garment portion.

14. A pneumatic compression garment as recited in claim 13, wherein the first group of tubes is operatively associated with a first pump connector manifold and the second group of tubes is operatively associated with a second pump connector manifold.

15. A pneumatic compression garment as recited in claim 13, wherein the first garment portion includes a separable chin strap that has a hook and loop type fastener arrangement associated therewith.

16. A pneumatic compression garment as recited in claim 13, wherein the second garment portion has a zippered front section.

17. A pneumatic compression garment as recited in claim 13, wherein each inflatable air chamber has a tube connector associated therewith, each of which includes a flange that is heat sealed to an interior surface of the garment.

18. A pneumatic compression garment as recited in claim 13, wherein the first garment portion has four separate and independently inflatable air chambers and the second garment portion has four separate and independently inflatable air chambers.

19. A pneumatic compression garment as recited in claim 18, wherein the first garment portion includes a front air chamber adapted and configured to partially surround the patient's face and forehead area, a medial upper air chamber adapted and configured to partially surround the patient's face and upper rear head area, a medial lower air chamber adapted and configured to partially surround the patient's lower rear head area and a bottom air chamber adapted and configured to partially surround the patient's rear neck area.

20. A pneumatic compression garment as recited in claim 18, wherein the four separate inflatable air chambers of the second garment portion extend substantially around an entire perimeter of the garment and include a lower air chamber, an upper air chamber and two medial air chambers therebetween, wherein the upper air chamber is in fluid communication with a left subordinate air chamber and a right subordinate air chamber, and wherein each subordinate air chamber is configured to surround a patient's shoulder area.

22. A pneumatic compression garment as recited in claim 20, wherein a left bridging tube extends between the upper air chamber of the second garment portion and the left subordinate air chamber to facilitate fluid communication therebetween and a right bridging tube extends between the upper air chamber of the second garment portion and the right subordinate air chamber to facilitate fluid flow therebetween.

23. A pneumatic compression garment as recited in claim 21, wherein interior left and right axilla air chambers are in respective fluid communication with the left and right subordinate air chambers.
